(19) United States
(12) Patent Application Publication
(10) Pub. No.: US 2013/0199410 A1
(43) Pub. Date: Aug. 8, 2013

(54) Methods and Compositions for Recycled Asphalt Shingles Material

(71) Applicant: ICL Performance Products LP, St. Louis, MO (US)

(72) Inventors: René Maldonado, Brentwood, MO (US); Enrique Elladio Romagosa, Holladay, UT (US); Darrel Fee, Chesterfield, MO (US); Olga Shulga, Ballwin, MO (US); Laurand Lewandowski, Newark, OH (US)

(73) Assignee: ICL Performance Products LP, St. Louis, MO (US)

(21) Appl. No.: 13/756,983

(22) Filed: Feb. 1, 2013

Related U.S. Application Data
(60) Provisional application No. 61/594,137, filed on Feb. 2, 2012.

(51) Int. Cl. C08L 95/00

(52) U.S. Cl. CPC C08L 95/00
USPC 106/281.1

(57) ABSTRACT

Certain aspects of the present invention are drawn recycled asphalt shingles-modified asphalt binder blends, mixes, and pavements, especially those comprising a mineral acid. Recycled asphalt shingles material may come from manufacturer asphalt shingle waste or from consumer asphalt shingle waste. It has been discovered that addition of a mineral acid significantly improves various rheological properties. Methods of making such asphalt binders, mixes, and pavements and their use are also disclosed.

### CROSS-REFERENCE TO RELATED APPLICATIONS

This application claims the benefit of U.S. Provisional Patent Application No. 61/594,137, filed Feb. 2, 2012, which is incorporated herein by reference in its entirety.

### BACKGROUND

An estimated 11 million tons of waste tear-off shingles removed from roofs and installation scrap is generated per year nationally (G. W. Maupin, Jr. “Investigation of the use of Tear-Off Shingles in Asphalt Concrete,” Virginia Transportation Research Council, May 1010; Hansen, K. R., Guidelines for Use of Reclaimed Asphalt Shingles in Asphalt Pavements Information Series 136, National Asphalt Pavement Association, Lanham, Md., 2009). More than 60 manufacturing plants across the U.S. generate another 750,000 to 1 million tons of manufacturing shingle waste. Shingles contain approximately 25% asphalt binder (John Davis “Roofing the Road—Using Asphalt Shingles as Binder” published in Asphalt (The magazine of the Asphalt Institute) Oct. 10, 2009), recycling of which could supply additional asphalt binder for road construction, providing great economic benefits. Potential other benefits from the use of scrap manufacturer shingles in hot mix asphalt (HMA) include improved resistance to pavement cracking due to reinforcement from fibers (Ross, B. “An Evaluation of The Use of Hot Mixed Asphalt Pavements Containing Roofing Shingle Material in North Carolina,” presented to the North Carolina Department of Environment, Health and Natural Resources, Raleigh, N.C., 1997; Lum, P., Greco, M., Yonke, E. “Field Performance and Laboratory Evaluation of Manufactured Shingle Modifier in HMA,” Canadian Technical Asphalt Association, 2004) and improved resistance to rutting due to fibers and increased stiffness of binder (Mallick, Rajib B., Teto, Mathew R., and Mogawar, Walaa “Evaluation of Use of Manufactured Waste Asphalt Shingles in Hot Mix Asphalt,” Technical Report #26, Chelsea Center for Recycling and Economic Development, 2000; Newcomb D., Stroup-Gardiner M., Weikle B., Drescher A. “Influence of Roofing Shingles on Asphalt Concrete Mixture Properties,” Report MN/RC-93/09, University of Minnesota, Dept. of Civil and Mineral Engineering, June 1993). Foo et al. (1999) summarize the application of roofing shingles in hot mix asphalt (Kee Foo, Douglas Hanson, Todd Lynn “Evaluation of roofing shingles in hot mix asphalt,” Journal of Materials in Civil Engineering, V. 11, No., 1, 1999, 15-20).

Modification of neat asphalt with recycled asphalt shingles material (RAS) (also sometimes referred to as reclaimed asphalt shingles) leads to an increase in stiffness at both high and low temperatures. While an increase in stiffness may be desirable in some cases, increased stiffness at low temperatures can be problematic in cold climates where the asphalt may become brittle and cause cracking of the finished asphalt material. Such undesirable properties limit the potential amount of RAS that can be used.

Further, the use of certain recycled asphalt shingles material from consumer asphalt shingle waste (that are also known as, tear off shingles) presents several challenges that do not exist with the use of manufacturer asphalt shingle waste. Consumer waste shingles have aged because of exposure to the elements, possibly causing brittleness that could decrease the durability of pavement comprising such shingles. Therefore improvements are especially needed to improve the usefulness of consumer asphalt shingle waste RAS-containing asphalt mixes, such as to meet Superpave specifications.

### SUMMARY OF THE INVENTION

The present invention provides for asphalt mixes comprising an asphalt binder, recycled asphalt shingles material, aggregate, and a mineral acid where the recycled asphalt shingles material may comprise manufacturer asphalt shingle waste, consumer asphalt shingle waste, or a combination of the two. In certain embodiments, the mineral acid is phosphoric acid. The asphalt binder may be a blend such as one comprising neat binder and binder extracted from recycled asphalt shingles material. In certain embodiments, the asphalt mix comprises from about 1 wt % to about 15 wt % of the recycled asphalt shingles material.

The present invention also provides for methods for producing a mineral acid-modified recycled asphalt shingles material-containing asphalt mix. Such methods comprise the steps of: (a) mixing an asphalt binder and a mineral acid to form a binder-acid intermediate; and (b) mixing the binder-acid intermediate with recycled asphalt shingles material and aggregate, thus producing a mineral acid-modified recycled asphalt shingles material-containing asphalt mix.

The present invention also provides for other methods for producing a mineral acid-modified recycled asphalt shingles material-containing asphalt mix comprising the steps of: (a) mixing an asphalt binder and recycled asphalt shingles material (RAS) to form a binder-RAS intermediate; and (b) mixing the binder-RAS intermediate with a mineral acid and aggregate, thus producing a mineral acid-modified recycled asphalt shingles material-containing asphalt mix.

The present invention also provides for preparing certain components of asphalt binder, recycles asphalt shingles material (RAS), and mineral acid separately. In certain embodiments, a method comprises the steps of: (a) mixing an asphalt binder and recycled asphalt shingles material (RAS) together to form a binder-RAS fraction; (b) separately mixing an asphalt binder and a mineral acid such as polyphosphoric acid together to from a binder-mineral acid fraction; (c) mixing the fractions of (a) and (b) together, thus combining at least a portion of the binder-RAS fraction and with at least a portion of the binder-mineral acid fraction; and (d) mixing an aggregate either during the mixing of fractions (a) and (b) or to the mixture resultant in step (c).

The present invention further provides for asphalt pavements comprising an asphalt binder, recycled asphalt shingles material, aggregate, and a mineral acid and asphalt binder blends comprising a neat asphalt binder and an asphalt binder extracted from recycled asphalt shingles material. In certain embodiments, the asphalt binder blend further comprising a mineral acid such as phosphoric acid.

### BRIEF DESCRIPTION OF THE DRAWING

FIG. 1. Hamburg Wheel Test results for PPA-modified RAS containing asphalt mixes. FIG. 1 presents the data for Hamburg Wheel Test for RAS-containing asphalt mixes with and without PPA modification.

### DETAILED DESCRIPTION

The recycled asphalt shingles material containing asphalt mixes of the invention are contemplated for, but not limited to, use in the construction of rolling surfaces such as roads, parking lots, bridges, highway, airport runways, walkways, playgrounds, pavement, and any other surfaces that may require a bituminous or asphalt coating.

Headings are provided herein solely for ease of reading and should not be interpreted as limiting.

### I. DEFINITIONS

The following definitions are provided to better define the present invention and to guide those of ordinary skill in the art in the practice of the invention. Unless otherwise noted, terms are to be understood according to conventional usage by those of ordinary skill in the relevant art.

Where a term is provided in the singular, the inventors also contemplate aspects of the invention described by the plural of that term unless otherwise indicated.

As used herein, the term “asphalts” refers to asphalt blends, asphalt mixes, asphalt pavements, and other asphalt compositions.

As used herein, “asphalt binder blends” or “asphalt blends” comprise different kinds of asphalt binder (bitumen). For example, the combination of a neat binder and binder extracted from recycled asphalt shingles material will make an asphalt blend.

As used herein, “asphalt mixes” comprise asphalt binder, aggregate, and other additives. Asphalt mixes are materials that may be compacted into pavement in road construction. As used herein, an “asphalt pavement” is a compacted asphalt mix.

As used herein, “compacted” refers to an asphalt mix containing asphalt binder, aggregate, and other additives that has been subjected to a vertical load to prepare asphalt pavement material.

As used herein, “Superpave specifications” (Superior Performing Asphalt Pavements) refer to specifications established by the Strategic Highway Research Program (SHRP) and incorporate performance-based characterization of asphalt materials with respect to environmental conditions. There are three major components of Superpave: binder specification (PG grading), design of the asphalt mix, and development of performance models.

As used herein, “PG grading” stands for Performance Grading which is a product of the Superpave specifications. Superpave Performance Grading is based on the idea that a hot mix asphalt binder's properties should be related to the conditions under which it is used. For asphalt binders, this involves expected climatic conditions as well as aging considerations. The PG system uses a common battery of tests that specify that a particular asphalt binder must pass such tests at specific temperatures that are based upon the specific climate conditions in the area of use.

As used herein, “RTFO” refers to rolling thin film oven. RTFO is a short term aging procedure intended to simulate behavior of asphalt during mixing and compaction. In the RTFO procedure, a thin film of sample is rolled inside of a bottle (sample holding vessel such as a glass vessel). The bottle is placed in an oven for 85 minutes at a temperature not exceeding 150° C.

As used herein, a “reference” composition (e.g., “reference asphalt mix” or “reference asphalt pavement”) refers to a composition that is identical to an inventive composition except differing in one or more components or variables that are specified. A reference composition is used for comparison to demonstrate improvements in an inventive composition over previous compositions.

All weights, parts, and percentages used herein are based on weight unless otherwise specified.

Concentrations, amounts, and other numerical data may be presented here in a range format (e.g., from about 5% to about 20%). It is to be understood that such range format is used merely for convenience and brevity, and should be interpreted flexibly to include not only the numerical values explicitly recited as the limits of the range, but also to include all the individual numerical values or sub-ranges encompassed within that range, as if each numerical value and sub-range is explicitly recited unless otherwise indicated. For example, a range of from about 5% to about 20% should be interpreted to include numerical values such as, but not limited to 5%, 5.5%, 9.7%, 10.3%, 15%, etc., and sub-ranges such as, but not limited to 5% to 10%, 10% to 15%, 8.9% to 18.9%, etc.

### II. OVERVIEW

The present invention provides for recycled asphalt shingles material (RAS) in asphalts with improved physical and rheological characteristics such as stiffness, effective temperature range, and low temperature properties. Certain aspects of the invention also provide for the use of binder extracted from RAS in asphalt blends. Certain embodiments provide for the addition of polyphosphoric acid (PPA) to minimize potential detrimental low-temperature effects of recycled asphalt shingles material while allowing for higher stiffness at high temperatures. It is contemplated that this may be especially useful when consumer asphalt shingle waste is the source of RAS or extracted binder. It has been discovered that the addition of PPA to asphalts leads to the widening of the effective temperature range. PPA acts to widen the effective range by improving both high and low temperature properties of asphalts. The invention is thus especially useful in the production of asphalt blends, mixes, and pavements with improved properties and will facilitate the recycling of asphalt shingles.

The asphalt binders used in various embodiments of the invention may be obtained from a variety of sources. Representative examples of useful asphalt binders include, but are not limited to, straight-run vacuum distilled, a mixture of vacuum residues with diluents such as vacuum tower wash oil, semi-blown asphalt, cut-back asphalt, natural asphalt, and asphalt produced by adding softener to petroleum tar. Other asphaltic materials such as coal tar pitch and rock asphalt are also contemplated as useful. Prior to being used, these asphalt binders are referred to as “neat” or “virgin” binders. Asphalts may be modified such as by addition of natural-rubber, synthetic rubber, thermoplastic elastomer, or mixtures thereof. Asphalts can also be modified with anti-stripping agents and other additives, including but not limited to lime, fibers, gilsonite, and combinations thereof. Different grades of asphalt are also contemplated for use such as hot mix asphalt, warm mix asphalt, stone mastic asphalts, and open grade asphalts.

### III. RECLAIMED ASPHALT SHINGLES MATERIAL (RAS)

There are at least two widely available sources of reclaimed asphalt shingles material. The first source is manufacturer asphalt shingle waste. After most shingles are manufactured, tabs are cut out to shape the shingles for assembly. These tabs contain fresh asphalt. Also discarded are new shingles that do not meet quality standards. A second source is consumer asphalt shingle waste. The majority of consumer waste shingles are tear-offs from re-roofing jobs or demolition debris. Consumer asphalt shingle waste contains aged asphalt whose properties vary from the asphalt in manufacturer asphalt shingle waste. The asphalt in consumer asphalt shingle waste may be hardened from oxidation and the volatilization of the lighter organic compounds. Further, consumer asphalt shingle waste material is often contaminated with nails, paper, wood, and other debris. To prepare reclaimed asphalt shingles material for use in new products, the shingles are ground to a specified size and contaminants are removed. This is typically performed at shingle recycling facilities or asphalt plants equipped with the necessary recycling equipment.

The shingles must be shredded or ground to be used successfully for virtually any road application. For hot mix asphalt (HMA) and cold patch, it is generally preferred that the shingles be shredded into a smaller size as they will incorporate better into the asphalt mix. Typically Departments of Transportation require that 100% of the shingle shreds pass through a 19 mm (¾ inch) sieve, and that 95% pass through a 12.5 mm (½ inch) sieve (A. Watson, Donald E., et al., Georgia's Experience with Recycled Roofing Shingles in Asphaltic Concrete, Georgia Department of Transportation, Forest Park, Ga., 1998; Button, Joe W., et al., Roofing Shingles and Toner in Asphalt Pavements, Research Report 1344-2F, Texas Transportation Institute, College Station, Tex., 1995; “Roofing Shingle Scrap,” User Guidelines for Waste and By-Product Materials in Pavement Construction, Publication FHWA RD-97-148, Federal Highway Administration, McLean, Va., 1998). Some Departments of Transportation require that 100% of the shingle shreds pass through a ½ inch sieve. Crushers, hammer mills, and rotary shredders have been used with various success to process waste shingles. Often the shingles are passed through the processing equipment twice for size reduction. Consumer waste shingles are generally easier to shred than manufacturer asphalt shingle waste. Manufacturer waste shingles tend to become plastic from the heat and mechanical action of the shredding process. Consumer asphalt shingle waste is hardened with age and therefore less likely to agglomerate during processing. Consumer asphalt shingle waste is much more variable in composition than factory scrap, and may be contaminated with debris which complicates processing for reuse. Nail removal may be accomplished with magnets after shredding. Paper and other lightweight contaminants may be removed by blowers or vacuums.

### IV. RAS-CONTAINING ASPHALT BINDER BLENDS

In one aspect of the invention, a mineral acid is contacted with asphalt material to produce an acid-treated asphalt binder. When added, the mineral acid content in the asphalt binder is from about 0.1 wt % to about 5 wt %. In certain embodiments, the mineral acid content in the asphalt binder is from about 0.2 wt % to about 1 wt %. The mineral acid may be one of a variety of mineral acids. Representative examples of mineral acids include, but are not limited to, hydrochloric, phosphoric, nitric, and sulfuric acids. In certain embodiments, the mineral acid is phosphoric acid. In certain embodiments, the phosphoric acid is in the form of phosphorus pentoxide, polyphosphoric acid (PPA) or superphosphoric acid. In certain embodiments, the phosphoric acid has a concentration in the range of from about 100% to about 118%.

Due to the presence of high concentrations of agglomerates of asphaltenes in certain recycled asphalt shingles material, RAS-containing asphalt binders are characterized by a decline of high and low temperature characteristics and therefore, a decline in PG grading. Without being bound by theory, it is believed that the addition of mineral acid acts as an asphaltene dispersing agent and that a better distribution of asphaltenes in maltene phase helps to improve rheological and physical properties of asphalt binders.

It has been demonstrated that with the aid of polyphosphoric acid, the rheological characteristics of asphalt binder blends containing binder extracted from recycled asphalt shingles material (RAS-containing binder) can be improved. It has been demonstrated that polyphosphoric acid-modified RAS-containing binders have decreased susceptibility to low temperature stress, compared to RAS-containing binders without polyphosphoric acid, which was demonstrated by the Direct Tension test. Higher Stress and Strain to Failure numbers were achieved for polyphosphoric acid-modified RAS-containing binder, meaning that pavement containing polyphosphoric acid-modified RAS-containing binder is able to withstand higher stress at low temperature and also undergo higher elongation without breaking which leads to improvements in low temperature cracking susceptibility of the pavement.

In one embodiment of the invention, a mineral acid-modified asphalt binder comprises a blend of asphalt binders. In certain embodiments, the asphalt binder blend comprises neat asphalt binder and asphalt binder extracted from recycled asphalt shingles material (“RAS-containing asphalt binder blend”). The asphalt binder extracted from recycled asphalt shingles material may be extracted from manufacturer asphalt shingle waste, from consumer asphalt shingle waste, or from a mixture of binders extracted from manufacturer and consumer asphalt shingle waste. In certain embodiments of the invention, an asphalt binder blend comprises from about 60 wt % to about 95 wt % of neat asphalt binder and from about 5 wt % to about 40 wt % of asphalt binder extracted from recycled asphalt shingle waste. In certain embodiments, the asphalt binder blend comprises the addition of from about 0.1 wt % to about 5.0 wt % polyphosphoric acid. In certain embodiments, the asphalt binder blend comprises the addition of from about 0.2 wt % to about 1.0 wt % polyphosphoric acid. Polyphosphoric acid modification has been found to improve the continuous temperature range and PG grading for both low and high temperature ends of RAS-containing asphalt binder blends. For example, in certain embodiments, a polyphosphoric acid-modified RAS-containing asphalt binder blend has a continuous temperature range of 83.9-26.5. For example, in certain embodiments, a polyphosphoric acid-modified RAS-containing asphalt binder blend has improved high temperature performance demonstrated by a higher value of complex shear modulus (G*) found for RAS-containing asphalt binder blend modified with polyphosphoric acid. Increase in complex shear modulus leads to increase in the value of stiffness (G*/sin δ). In certain embodiments, a polyphosphoric acid-modified RAS-containing asphalt binder blend has a stiffness value of 3.850 kPa at 82° C. For comparison, a RAS-containing asphalt blend without modification was found to have a stiffness value of 3.340 kPa at 76° C. In certain embodiments, a polyphosphoric acid-modified RAS-containing asphalt binder blend exhibits improved elastic properties demonstrated by a decrease in phase angle (δ). In certain embodiments, a polyphosphoric acid-modified RAS-containing asphalt binder blend has a phase angle of 78.0° at 82° C. For comparison, addition of RAS to neat asphalt binder blend in an un-aged sample decreased the phase angle from 85.3° at 58° C. t 81.4° at 76° C. This same trend in phase angle was also found for RTFO-aged samples. In certain embodiments, modification of RAS-containing asphalt binder blend with polyphosphoric acid improves both the stiffness and the elasticity of the asphalt. This is useful in improving rutting and fatigue resistance. In certain embodiments, a polyphosphoric acid-modified RAS-containing asphalt binder blend exhibits improved low temperature properties as compared to a reference unmodified RAS-containing asphalt binder blend. In certain embodiments, a polyphosphoric acid-modified RAS-containing asphalt binder blend exhibits a higher strain to failure as compared to a reference unmodified RAS-containing asphalt binder blend. This is useful in obtaining a lower critical cracking temperature for the asphalt.

### V. RAS-CONTAINING ASPHALT MIXES

In one aspect of the invention, a mineral acid is contacted with asphalt material to produce an acid-treated asphalt. When added, the mineral acid content in the asphalt is from about 0.1 wt % to about 5.0 wt %. In certain embodiments, the mineral acid content in the asphalt is from about 0.2 wt % to about 1.0 wt %. The mineral acid may be one of a variety of mineral acids. Representative examples of mineral acids include, but are not limited to, hydrochloric, phosphoric, nitric, and sulfuric acids. In certain embodiments, the acid is phosphoric acid. In certain embodiments, the phosphoric acid is in the form of orthophosphoric acid, polyphosphoric acid (PPA), or superphosphoric acid. In certain embodiments, the phosphoric acid has a concentration in the range of from about 100% to about 118%.

Certain embodiments of the invention are drawn to an asphalt mix comprising an asphalt binder, recycled asphalt shingles material, aggregate, and a mineral acid. In certain embodiments, the asphalt binder is a neat binder. The asphalt binder may also be an asphalt binder blend comprising binder extracted from recycled asphalt shingles material and another source of asphalt binder, such as neat asphalt binder. In certain preferred embodiments, the mix comprises binder in the range of from about 2 wt % to about 8 wt %. Binder extracted from recycled asphalt shingles material may be extracted from manufacturer asphalt shingle waste, consumer asphalt shingle waste, or a mixture of the two. In certain embodiments, the asphalt binder blend comprises from about 60 wt % to about 95 wt % neat binder and from about 5 wt % to about 40 wt % binder extracted from recycled asphalt shingles material.

The recycled asphalt shingles material added to the binder, aggregate, and mineral acid, may be from manufacturer asphalt shingle waste, consumer asphalt shingle waste, or a mixture of the two. In certain embodiments, the asphalt mix comprises from about 1 wt % to about 15 wt % of the recycled asphalt shingles material. In certain embodiments, the asphalt mix comprises from about 3 wt % to about 7 wt % of the recycled asphalt shingles material. In certain embodiments, the asphalt mix comprises from about 5 wt % to about 15 wt % of the recycled asphalt shingles material. In certain embodiments, the asphalt mix comprises from about 5 wt % to about 10 wt % of the recycled asphalt shingles material. In certain embodiments, the asphalt mix comprises from about 10 wt % to about 15 wt % of the recycled asphalt shingles material.

Asphalt mixes can be prepared by applying mechanical or thermal convection. One aspect of the invention is drawn to the method of preparing an asphalt mix by mixing the asphalt with mineral acid in addition to RAS and aggregate at a temperature of from about 100° C. to about 250° C. In certain embodiments, the asphalt is mixed with mineral acid in addition to RAS and aggregate at a temperature of from about 125° C. to about 175° C. The aggregate may be any of those known to be useful in the preparation of asphalt mixes such as, but not limited to, limestone, granite, and trap rock. The order of mixing the components of the asphalt mix is not limited. The mix may be prepared by mixing the asphalt binder with phosphoric acid followed by the addition of RAS and the aggregate. The binder may also be mixed first with RAS, followed by addition of mineral acid and the aggregate. In yet another embodiment, the binder, mineral acid, and RAS are added together at the same time, followed by the addition of the aggregate. One of skill in the art will recognize that other sequences of adding and mixing components are possible.

Due to the presence of high concentrations of agglomerates of asphaltenes in recycled asphalt shingles material, RAS-containing asphalt binders are characterized by a decline of high and low temperature characteristics and therefore, a decline in PG grading. Without being bound by theory, it is believed that mineral acids acts as an asphaltene dispersing agent and that a better distribution of asphaltenes in maltene phase helps to improve rheological and physical properties of asphalt binders.

It has been discovered that with the aid of polyphosphoric acid, the rheological characteristics of RAS-containing asphalt mixes and pavements can be improved. It has been demonstrated that pavement produced by mixing polyphosphoric acid with an RAS-containing asphalt mix has low susceptibility to rutting as demonstrated in testing using the Hamburg Wheel Tracking Device. Pavement that contains RAS and polyphosphoric acid requires a higher number of passes to achieve a specified rut depth. Such pavements are also less susceptible to stripping since the stripping inflection point was achieved at a higher number of passes. Furthermore, such pavements demonstrated a superior strength at low temperature as confirmed by the Disk Shape Compaction Tension test.

In certain embodiments, the mix comprises binder in the range of from about 2 wt % to about 8 wt % and RAS in the range of from about 2 wt % to about 15 wt %, wherein the components of the asphalt mix are incorporated in any order at a temperature of from about 250° F. to about 350° F.

In certain embodiments, 0.5 wt % PPA (105%) is added to PG 58-28 binder under low shear mixing at a temperature of about 250° F. to about 325° F. to make PG 64-22 binder. This binder is then mixed with 5% RAS and aggregate. Mixing of binder, RAS, and aggregate is done at a temperature of from about 300° F. to about 320° F.

In certain embodiments, pavements comprising PPA-modified RAS-containing asphalt mixes have improved pavement deformation resistance (rutting). In certain embodiments, pavements comprising PPA-modified RAS-containing asphalt mixes have improved moisture resistance. In certain embodiments, pavements comprising PPA-modified RAS-containing asphalt mixes have improved low temperature fracture properties.

### VI. EXAMPLES

The following disclosed embodiments are merely representative of the invention which may be embodied in various forms. Thus, specific structural, functional, and procedural details disclosed in the following examples are not to be interpreted as limiting.

In the following Examples, blends of neat asphalt and asphalt extracted from recycled asphalt shingles material as well as asphalt mixes containing recycled asphalt shingles material were tested in terms of low temperature performance, pavement deformation (rutting), and moisture resistance, as well as low temperature fracture properties.

### Example 1

In order to evaluate the effect of addition of polyphosphoric acid on RAS-containing asphalt mixes, the following samples were prepared: (Sample 1) 5.2 wt % of neat binder PG 58-28 was mixed with 5% consumer waste RAS and trap rock aggregate and used as a control; (Sample 2) vacuum distilled PG 64-22 binder was mixed with 5% RAS and trap rock aggregate and used as a second control; (Sample 3) 0.5 wt % PPA was added to PG 58-28 binder to make PG 64-22 binder and then it was mixed with 5% RAS and trap rock aggregate and used as a test sample. Addition of polyphosphoric acid to PG 58-28 binder was performed at 325° F. with mixing under low shear. Mixing of all samples was performed in the temperature range of 148° C. to 157° C. Both control and test samples were compacted using a Gyratory Compactor at 136° C. to 145° C. following the Superpave Gyratory Compaction (SGC) method. The SGC method produces asphalt mix specimens to densities achieved under actual pavement climate and loading conditions. The procedure performed in the lab simulates the action of rollers used to compact asphalt pavements by applying a vertical load to an asphalt mixture while gyrating a mold tilted at a specific angle. According to this procedure (ASTM D 6925), a hot mix asphalt sample is placed in a rigid frame (steel mold) and the mold is placed in a Superpave Gyratory Compactor where standard pressure of 600 kPa is applied. Compaction occurs due to the pressure from the ram and the kneading action provided by the revolving angle of the lower and upper plates of the SGC machine. Therefore, the following samples were prepared using the above mentioned procedure:

Sample 1 (first control): neat PG 58-25+5% RAS+aggregate

Sample 2 (second control): PG 64-22 (vacuum)+5% RAS+aggregate

Sample 3 (test sample): PG 64-22 (PPA)+5% RAS+aggregate

Properties of the compacted asphalt mixes were investigated using a Hamburg Wheel Tracking device in order to study susceptibility of the sample to rutting and Disc Shaped Compaction Tension Test in order to study low temperature fracture properties of the samples. Table 1 contains test results for these samples.

TABLE 1
Results for RAS-containing asphalt mixes with
and without polyphosphoric acid (PPA).

| | Test | | |
|---|---|---|---|
| | | | Sample 3: PG |
| | Sample 1: neat | Sample 2: PG 64-22 | 64-22 (PPA) + |
| | PG 58-28 + 5% | (vacuum) + 5% | 5% RAS + |
| | RAS + | RAS + aggregate | aggregate (with |
| | aggregate | (no PPA) | PPA) |
| | (control 1) | (Control 2) | (Test Sample) |
| Hamburg | 12.5 mm after | 12.4 mm after 13,500 | 11.5 mm after |
| Wheel | 9,050 passes. | passes. Stripping | 20,000 passes. |
| Tracking | Stripping | inflection point is | Stripping |
| | inflection point is | reached after 6,000 | inflection |
| | reached after | passes. | point is reached |
| | 7,250 passes. | | after 15,100 |
| | | | passes. |
| Disk-Shaped | 880 J/m² | 678 J/m² | 1,103 J/m² |
| Compaction | | | |
| Tension | | | |

As shown in Table 1, polyphosphoric acid-modified RAS-containing asphalt mix show significantly higher resistance to rutting, showing 11.5 mm impression reached after maximum of 20,000 passes. Also the stripping inflection point for the polyphosphoric acid-modified samples was substantially better with a value of 15,100 passes.

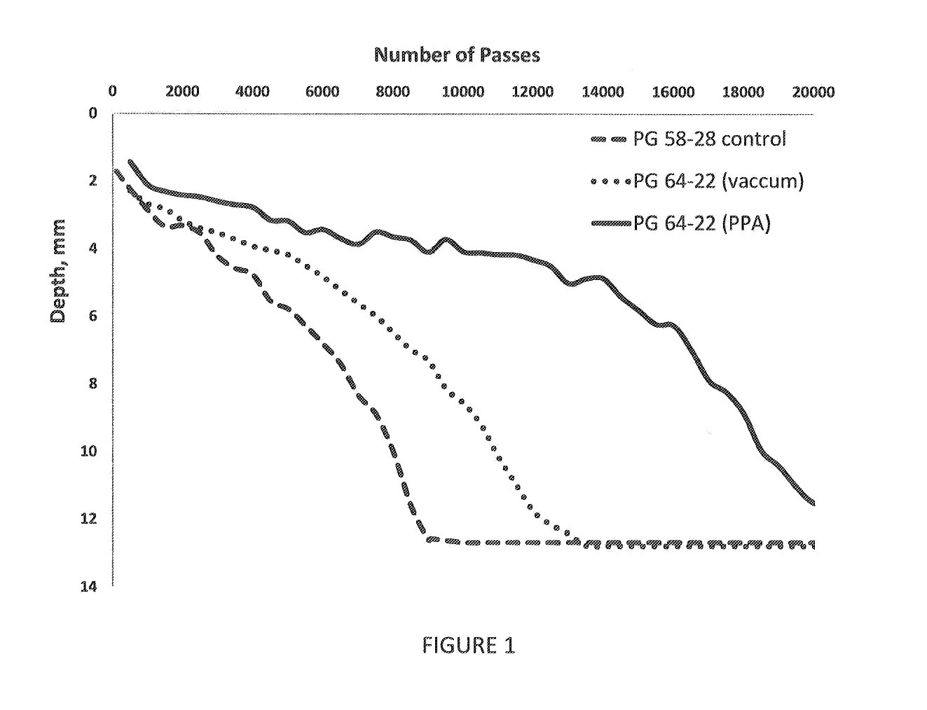

FIG. 1 presents the data for the Hamburg Wheel Test for RAS-containing asphalt mixes with and without polyphosphoric acid modification. As seen from FIG. 1, for samples without polyphosphoric acid, the depth of the rut was found to be 12 mm as it was achieved after 9,000 cycles for Sample 1 and 13,500 cycles for Sample 2. In the presence of polyphosphoric acid, the depth of the rut was found to be 11 mm after 20,000 cycles. This result shows that significant resistance to rutting may be achieved for polyphosphoric acid-modified RAS-containing mixes. The stripping inflection point was found to be lower for Samples 1 and 2. In particular, for Sample 1, it was found to be at 7,250 cycles and for Sample 2, it was found to be at 6,000 cycles. These results indicate that without polyphosphoric acid, asphalt mixes will be very susceptible to moisture damage. In the presence of polyphosphoric acid, inflection point is achieved at 15,000 cycles.

Table 1 also shows the results of the Disk-Shaped Compaction Tension testing performed to determine the low temperature fracture properties of the various mixes. The polyphosphoric acid-modified mix displayed the higher fracture energy and was 20-35% higher than the PG 58-28 and PG 64-22 (vacuum) samples that did not contain polyphosphoric acid. This data supports observed binder results that showed the polyphosphoric acid-modified RAS blends showed better low temperature fracture properties.

### Example 2

In this example, the effect of polyphosphoric acid on binder extracted from RAS was evaluated. The experiments illustrate the direct effect of polyphosphoric acid on the recovered binder, which in turn helps explain the benefits obtained when regular RAS material is used. An asphalt blend consisting of neat (unmodified) asphalt (GP 58-28), binder extracted from consumer waste RAS, and polyphosphoric acid was prepared as described herein. Consumer waste RAS was dissolved in toluene in order to extract the binder. After evaporation of the solvent, the extracted binder was mixed with neat asphalt binder using the ratio of 25% extracted binder to 75% virgin binder. 0.5 wt % of polyphosphoric acid was slowly added to the blend and mixed under low shear for 30 minutes at 325° F. Neat binder (without RAS or polyphosphoric acid) and binder modified with extracted RAS binder (no polyphosphoric acid) were used as controls. The binders were graded according to AASHTO M320 specification for PF 58-28 binder. Findings are presented in Table 2.

TABLE 2
Superpave properties of RAS-containing asphalt blends
with and without polyphosphoric acid (PPA).

| | | | PG 58-28 | PG 58-28 |
|---|---|---|---|---|
| | AASHTO | PG 58-28 | binder + | binder + |
| | test | Binder | Extracted | Extracted |
| | method | Control | RAS | RAS + PPA |
| Viscosity | M 320 | 0.303 | 0.870 | 1.290 |
| DSR, kPA (G*/sinδ) | | Out of | 0.650 | 1.230 |
| @82° C. | | spec. | | |
| DSR, kPA (G*/sinδ) | | Out of | 1.650 | 3.850 |
| @82° C. after RTFO | | spec. | | |
| Continuous Grade | | 78.2-25.3 | 83.9-26.5 | 83.7-27.8 |

As shown in Table 3, modification of RAS-containing asphalt blends with polyphosphoric acid leads to a significant increase in DSR value at 82° C., which significantly widens useful temperature interval and may imply better resistance to rutting when the asphalt is in the mix. The improvement in the useful temperature interval is demonstrated by continuous grade, which is found to be 83.7-27.8 for polyphosphoric acid-containing asphalt blend.

A blend consisting of 75 wt % PG 58-28 and 25 wt % recovered RAS binder without polyphosphoric acid and with 0.5 wt % polyphosphoric acid was tested for the amount of binder stress according to AASHTO T314. Results of this test are presented in Table 3. Low temperature testing (Direct Tension Test) indicated that low temperature performance of polyphosphoric acid-modified RAS-containing asphalt blends improved significantly upon addition of polyphosphoric acid, which is demonstrated by increase of the stress value for polyphosphoric acid-modified RAS-containing asphalt blends. In particular, stress value for polyphosphoric acid-modified RAS-containing asphalt blends increased from 2.255 MPa (without polyphosphoric acid) to 2.478 MPa (with polyphosphoric acid) at −12° C. and from 1.810 MPa (without polyphosphoric acid) to 3.353 MPa (with polyphosphoric acid) at −24° C., indicating that the polyphosphoric acid-modified sample is able to withstand higher stress.

Strain to failure (not shown) also increased from 1.979% for sample without polyphosphoric acid to 3.192% for sample with polyphosphoric acid. This indicates that in the presence of polyphosphoric acid, the sample may undergo higher elongation without breaking, with ultimately better elasticity of polyphosphoric acid-containing samples.

TABLE 3
Variation of stress fracture (MPa) value for polyphosphoric
acid-modified RAS binder.

| | |
|---|---|
| | 75 wt % PG 58-28 w/25 wt |
| Testing | % RAS Binder |

| temperature ° C. | No Additive | 0.5 wt % PPA |
|---|---|---|
| −12° C. | 2.255 | 2.478 |
| −18° C. | 2.502 | 3.653 |
| −24° C. | 1.810 | 3.353 |

What is claimed is:

1. An asphalt mix comprising an asphalt binder, recycled asphalt shingles material, aggregate, and a mineral acid, wherein the recycled asphalt shingles material is selected from the group consisting of manufacturer asphalt shingle waste, consumer asphalt shingle waste, and combinations thereof.

2. The asphalt mix of claim 1 wherein the mineral acid is a phosphoric acid selected from the group consisting of orthophosphoric acid, polyphosphoric acid, and superphosphoric acid.

3. The asphalt mix of claim 1 wherein the recycled asphalt shingles material comprises consumer asphalt shingle waste.

4. The asphalt mix of claim 1 wherein the asphalt binder is a blend comprising neat binder and binder extracted from recycled asphalt shingles material.

5. The asphalt mix of claim 1 wherein the mineral acid is selected from the group consisting of hydrochloric acid, phosphoric acid, nitric acid, and sulfuric acid.

6. The asphalt mix of claim 1 wherein the phosphoric acid is polyphosphoric acid.

7. The asphalt mix of claim 1 wherein the asphalt mix comprises from about 0.1 wt % to about 5.0 wt % polyphosphoric acid.

8. The asphalt mix of claim 1 wherein the asphalt mix comprises from about 1 wt % to about 15 wt % recycled asphalt shingles material.

9. The asphalt mix of claim 1 wherein the asphalt mix comprises from about 10 wt % to about 15 wt % recycled asphalt shingles material.

10. A method of producing a mineral acid-modified recycled asphalt shingles material-containing asphalt mix, the method comprising the steps of: (a) mixing an asphalt binder and a mineral acid to form a binder-acid intermediate; and (b) mixing the binder-acid intermediate with recycles asphalt shingles material (RAS) and aggregate, thus producing a mineral acid-modified recycled asphalt shingles material-containing asphalt mix, wherein the recycled asphalt shingles material is selected from the group consisting of manufacturer asphalt shingle waste, consumer asphalt shingle waste, and combinations thereof.

11. The method of claim 10 wherein in step (b) the binder-acid intermediate is mixed with the recycled asphalt shingles material (RAS) to form a binder-acid-RAS intermediate and then the binder-acid-RAS intermediate is mixed with aggregate or the binder-acid intermediate is mixed with aggregate to form a binder-acid-aggregate intermediate and then the binder-acid-aggregate intermediate is mixed with RAS, thus producing a mineral acid-modified recycled asphalt shingles material containing asphalt mix.

12. The method of claim 10 wherein the binder-acid intermediate is mixed with the recycled asphalt shingles material and aggregate at a temperature of from about 148° C. to about 157° C.

13. The method of claim 10 wherein the mineral acid is a phosphoric acid selected from the group consisting of orthophosphoric acid, polyphosphoric acid, and superphosphoric acid.

14. The method of claim 10 wherein the recycled asphalt shingles material comprises consumer asphalt shingle waste.

15. The method of claim 10 wherein the asphalt binder is a blend comprising neat binder and binder extracted from recycled asphalt shingles material.

16. The method of claim 10 wherein the mineral acid is selected from the group consisting of hydrochloric acid, phosphoric acid, nitric acid, and sulfuric acid.

17. The method of claim 10 wherein the phosphoric acid is polyphosphoric acid.

18. The method of claim 10 wherein the asphalt mix comprises from about 0.1 wt % to about 5.0 wt % polyphosphoric acid.

19. The method of claim 10 wherein the asphalt mix comprises from about 1 wt % to about 15 wt % recycled asphalt shingles material.

20. The method of claim 10 wherein the asphalt mix comprises from about 10 wt % to about 15 wt % recycled asphalt shingles material.

21. A method of producing a mineral acid-modified recycled asphalt shingles material-containing asphalt mix, the method comprising the steps of: (a) mixing an asphalt binder and recycled asphalt shingles material (RAS) to form a binder-RAS intermediate; and (b) mixing the binder-RAS intermediate with a mineral acid and aggregate, thus producing a mineral acid-modified recycled asphalt shingles material-containing asphalt mix, wherein the recycled asphalt shingles material is selected from the group consisting of manufacturer asphalt shingle waste, consumer asphalt shingle waste, and combinations thereof.

22. The method of claim 21 wherein in step (b) the binder-RAS intermediate is mixed with the mineral acid to form a binder-RAS-acid intermediate and then the binder-RAS-acid intermediate is mixed with aggregate or the binder-RAS intermediate is mixed with aggregate to form a binder-RAS-aggregate intermediate and then the binder-RAS-aggregate intermediate is mixed with mineral acid, thus producing a mineral acid-modified recycled asphalt shingles material containing asphalt mix.

23. The method of claim 21 wherein the mineral acid is a phosphoric acid selected from the group consisting of orthophosphoric acid, polyphosphoric acid, and superphosphoric acid.

24. The method of claim 21 wherein the recycled asphalt shingles material comprises consumer asphalt shingle waste.

25. The method of claim 21 wherein the asphalt binder is a blend comprising neat binder and binder extracted from recycled asphalt shingles material.

26. The method of claim 21 wherein the mineral acid is selected from the group consisting of hydrochloric acid, phosphoric acid, nitric acid, and sulfuric acid.

27. The method of claim 21 wherein the phosphoric acid is polyphosphoric acid.

28. The method of claim 21 wherein the asphalt mix comprises from about 0.1 wt % to about 5.0 wt % polyphosphoric acid.

29. The method of claim 21 wherein the asphalt mix comprises from about 1 wt % to about 15 wt % recycled asphalt shingles material.

30. The method of claim 21 wherein the asphalt mix comprises from about 10 wt % to about 15 wt % recycled asphalt shingles material.

31. An asphalt pavement comprising an asphalt binder, recycled asphalt shingles material, aggregate, and a mineral acid, wherein the recycled asphalt shingles material is selected from the group consisting of manufacturer asphalt shingle waste, consumer asphalt shingle waste, and combinations thereof.

32. The asphalt pavement of claim 31 wherein the mineral acid is a phosphoric acid selected from the group consisting of orthophosphoric acid, polyphosphoric acid, and superphosphoric acid.

33. The asphalt pavement of claim 31 wherein the recycled asphalt shingles material comprises consumer asphalt shingle waste.

34. The asphalt pavement of claim 31 wherein the asphalt binder is a blend comprising neat binder and binder extracted from recycled asphalt shingles material.

35. The asphalt pavement of claim 31 wherein the mineral acid is selected from the group consisting of hydrochloric acid, phosphoric acid, nitric acid, and sulfuric acid.

36. The asphalt pavement of claim 31 wherein the phosphoric acid is polyphosphoric acid.

37. The asphalt pavement of claim 31 wherein the asphalt mix comprises from about 0.1 wt % to about 5.0 wt % polyphosphoric acid.

38. The asphalt pavement of claim 31 wherein the asphalt mix comprises from about 1 wt % to about 15 wt % recycled asphalt shingles material.

39. The asphalt pavement of claim 31 wherein the asphalt mix comprises from about 10 wt % to about 15 wt % recycled asphalt shingles material.
